(19) United States
(12) Patent Application Publication
(10) Pub. No.: US 2011/0315612 A1
(43) Pub. Date: Dec. 29, 2011

(54) DESALINATION APPARATUS AND METHOD OF CLEANING THE SAME

(75) Inventors: Hidemasa Kakigami, Nagasaki (JP); Yoshiaki Ito, Nagasaki (JP); Kazuhisa Takeuchi, Nagasaki (JP); Katsunori Matsui, Nagasaki (JP); Hideo Iwahashi, Nagasaki (JP)

(73) Assignee: MITSUBISHI HEAVY INDUSTRIES, LTD., Tokyo (JP)

(21) Appl. No.: 13/255,210

(22) PCT Filed: Aug. 7, 2009
(86) PCT No.: PCT/JP2009/064060

§ 371 Date: Sep. 7, 2011

(30) Foreign Application Priority Data
Mar. 11, 2009 (JP) 2009-058070

(51) Int. Cl. C02F 1/44; B01D 65/02

(52) U.S. Cl. 210/97; 210/636

(57) ABSTRACT

A desalination apparatus according to the present invention includes: a pretreatment device having a pretreatment membrane that filters a turbid content contained in raw water; a reverse osmosis membrane device having a reverse osmosis membrane that reduces a salt content contained in filtrate water supplied from the pretreatment device to produce permeated water; a first control valve that is provided between a high-pressure pump mounted on a filtrate water line through which the filtrate water is supplied from the pretreatment device to the reverse osmosis membrane device and the reverse osmosis membrane device, and temporarily decreases a supply pressure of the filtrate water; and the control device that operates the first control valve to perform suck-back control by which a pressure at the entrance of the reverse osmosis membrane device is decreased in a pulse-like manner during operation.

### TECHNICAL FIELD

The present invention relates to a desalination apparatus capable of removing a contamination layer on a reverse osmosis membrane without stopping seawater desalination, thereby continuously performing the seawater desalination and a method of cleaning the same.

### BACKGROUND ART

An evaporating method and a reverse osmosis method are known as methods to obtain pure water from seawater as raw water. In the evaporating method, seawater is evaporated. In the reverse osmosis method, pressure is applied to seawater, and the seawater is filtered through a kind of filter membrane called a reverse osmosis membrane (RO membrane: reverse osmosis membrane), thereby condensing the salt content of the seawater. The condensed salt content is disposed, and thus, plain water is obtained.

An energy efficiency of the reverse osmosis method is superior to an energy efficiency of the evaporating method. The reverse osmosis method, however, requires careful pretreatment and constant maintenance so that an RO membrane is not clogged with microbes in seawater and deposition substance. More specifically, in such pretreatment, a turbid content in the seawater as raw water is reduced by employing an ultrafiltration membrane (UF membrane) or a microfilter membrane (MF membrane).

To reduce such turbid content, reducing methods are proposed in which chemicals such as alkali and acid are used. Such chemicals are, however, hazardous and difficult to handle. Moreover, waste liquid treatment is cumbersome when the chemicals are used. Another method is also proposed in which a membrane surface is cleaned by employing forward osmotic phenomenon during operation. In the method, however, a sodium chloride solution having a high density of 25 percent is required (Nonpatent Document 1: Boris Liberman et. al., “Replacing membrane CIP by direct osmosis cleaning”, The international desalination & water reuse quarterly, 15(2), 28-32 (2005)).

An example of such conventional maintenance is described with reference to FIG. 6. FIG. 6 is a schematic of a desalination apparatus according to a conventional technology.

As shown in FIG. 6, this desalination apparatus 100A according to the conventional technology includes: a pretreatment device 13 having a pretreatment membrane 12 that filters a turbid content contained in raw water (seawater) 11; and a reverse osmosis membrane device 17 having a reverse osmosis membrane (RO membrane) 16 that reduces a salt content contained in filtrate water 14 supplied from the pretreatment device 13, thereby obtaining permeated water 15. The desalination apparatus 100A filters the raw water (seawater) 11 with the pretreatment device 13, and applies an operating pressure that is larger than the osmotic pressure on the water supply side of the RO membrane 16 with a high-pressure pump 21. Thus, a salt content contained in the filtrated water 14 is reduced, and the desalination treatment is performed to obtain permeated water 15.

Incidentally, the reference numeral 22 indicates a raw water line through which the raw water 11 is supplied to the pretreatment device 13. The reference numeral 23 indicates a filtrate water line through which the filtrate water 14 is supplied to the reverse osmosis membrane device 17. The reference numeral 24 indicates a concentrated water line through which concentrated water 18 that is concentrated by the reverse osmosis membrane device 17 is discharged. The reference numeral 25 indicates permeated water line through which the permeated water 15 is supplied to a facility such as a water use facility that is provided outside.

In such a facility, use of a simple flushing method is proposed to reduce a turbid content that have deposited on the surface of the RO membrane 16 is reduced after operating for a predetermined period of time (see Patent Document 1).

In the method, the RO membrane 16 that separates the raw water forcibly fed by the high-pressure pump into concentrated water and permeated water is an osmosis membrane, and thus, a turbid content clogged on the surface of the RO membrane is reduced by repeating starting and stopping the operation performed by a high-pressure pump.

The method requires that the high-pressure pump is stopped. Thus, the method can be applied to a small- or a middle-sized seawater desalination facility. In a large sized seawater desalination facility, however, once a high-pressure pump is stopped, it takes time to return to a steady state. Therefore, the method cannot be applied thereto.

Therefore, a method is proposed in which a turbid content is reduced without stopping the seawater desalination (Patent Document 2).

FIG. 7 is a schematic of another desalination apparatus according to a conventional technology.

As shown in FIG. 7, in this desalination apparatus 100B according to the conventional technology, an on-off valve 26 is mounted on the concentrated water line 24. Thus, by reducing an amount of the supplied raw water 11 and increasing an opening degree of the on-off valve 26 mounted thereon, current speed of the fluid in the reverse osmosis membrane device 17 is increased, thereby reducing a gel layer that is the turbid content by the filtrated water 14.
[Patent Document 1] Japanese Patent Application Laid-open No. S61-133104
[Patent Document 2] Japanese Patent Application Laid-open No. S63-93304
[Nonpatent Document 1] Boris Liberman et. al., “Replacing membrane CIP by direct osmosis cleaning”, The international desalination & water reuse quarterly, 15(2), 28-32 (2005)

### DISCLOSURE OF INVENTION

### Problem to be Solved by the Invention

In the proposed desalination apparatus 100B according to the conventional technology as shown in FIG. 7, however, the on-off valve 26 is mounted on the concentrated water line 24, and pressure fluctuation occurs by the opening/closing operation thereof. Thus, an energy recovery device by which energy of the concentrated water 18 is recovered cannot be installed in the desalination apparatus 100B, which leads to degradation of the energy efficiency of the whole system of such a seawater facility.

Recently in a seawater desalination facility, an inexpensive desalination apparatus operating under low running cost is called for with which the seawater desalination can be continuously performed without using chemicals, and an energy efficiency of the facility and a production efficiency of seawater desalination can be enhanced.

In view of the foregoing, an object of the present invention is to provide a desalination apparatus capable of reducing a turbid layer on a reverse osmosis membrane without stopping desalination, thereby continuously performing the desalination, and a method of cleaning the same.

### Means for Solving Problem

According to an aspect of the present invention, a desalination apparatus includes: a pretreatment device having a pretreatment membrane that filters a turbid content contained in raw water; a reverse osmosis membrane device having a reverse osmosis membrane that reduces a salt content contained in filtrate water supplied from the pretreatment device to produce permeated water; a first control valve that is provided between a high-pressure pump mounted on a filtrate water line through which the filtrate water is supplied from the pretreatment device to the reverse osmosis membrane device and the reverse osmosis membrane device, and that temporarily decreases a supply pressure of the filtrate water; and a control device that controls the first control valve to decrease an inlet pressure of the reverse osmosis membrane device in a pulse-like manner during operation.

According to another aspect of the present invention, a desalination apparatus includes: a pretreatment device having a pretreatment membrane that filters a turbid content contained in raw water; a reverse osmosis membrane device having a reverse osmosis membrane that reduces a salt content contained in filtrate water supplied from the pretreatment device to produce permeated water; a second control valve that is mounted on a permeated water line through which the permeated water is supplied from the reverse osmosis membrane device, and temporarily increases a pressure of the permeated water; and a control device that controls the second control valve to increase a pressure of the permeated water in a pulse-like manner during operation.

According to still another aspect of the present invention, a desalination apparatus includes: a pretreatment device having a pretreatment membrane that filters a turbid content contained in raw water; a reverse osmosis membrane device having a reverse osmosis membrane that reduces a salt content contained in filtrate water supplied from the pretreatment device to produce permeated water; a first control valve that is provided between a high-pressure pump mounted on a filtrate water line through which the filtrate water is supplied from the pretreatment device to the reverse osmosis membrane device and the reverse osmosis membrane device, and temporarily decreases a supply pressure of the filtrate water; a second control valve that is mounted on a permeated water line through which permeated water is supplied from the reverse osmosis membrane device, and temporarily increases a pressure of the permeated water; and a control device that controls any one of the first control valve and the second control value or both of them to perform any one of an operation by which a pressure at an entrance of the reverse osmosis membrane device is decreased in a pulse-like manner during operation and an operation by which a pressure of the permeated water is increased in a pulse-like manner during operation or both of them.

Advantageously, the desalination apparatus further includes an energy recovery device that is mounted on a concentrated water line, and recovers energy of concentrated water having a high pressure.

According to still another aspect of the present invention, a method of cleaning a desalination apparatus by using a reverse osmosis membrane device having a reverse osmosis membrane that reduces a salt content contained in raw water to produce permeated water, includes: providing a first control valve that temporarily decreases a supply pressure of the raw water to the reverse osmosis membrane device; decreasing an inlet pressure of the reverse osmosis membrane device in a pulse-like manner during operation; generating a reverse flow due to forward osmosis; and cleaning a surface of the reverse osmosis membrane.

According to still another aspect of the present invention, a method of cleaning a desalination apparatus by using a reverse osmosis membrane device having a reverse osmosis membrane that reduces a salt content contained in raw water to produce permeated water, includes: providing a second control valve that temporarily increases a pressure of the permeated water supplied from the reverse osmosis membrane device, increasing a pressure of the permeated water in a pulse-like manner during operation; generating a reverse flow due to forward osmosis; and cleaning a surface of the reverse osmosis membrane.

### Effect of the Invention

According to the present invention, a contamination layer on a reverse osmosis membrane can be removed without stopping seawater desalination, thereby continuously performing the seawater desalination.

### BRIEF DESCRIPTION OF DRAWINGS

FIG. 1 is a schematic of a desalination apparatus according to a first embodiment of the present invention.

FIG. 2 is a schematic of a desalination apparatus according to a second embodiment of the present invention.

FIG. 3 is a schematic of a desalination apparatus according to a third embodiment of the present invention.

FIG. 4 is a diagram depicting relationship between an elapsed time of operation, an amount of permeated water, and a supply pressure according to a test.

FIG. 5 is a diagram depicting an amount of permeated water fluctuation according to the test.

FIG. 6 is a schematic of a desalination apparatus according to a conventional technology.

FIG. 7 is a schematic of another desalination apparatus according to the conventional technology.

### BEST MODE(S) FOR CARRYING OUT THE INVENTION

The present invention is described with reference to an accompanying drawing. The present invention is, however, not limited thereto. The constituent elements described in the embodiments below include various modifications that will readily occur to those skilled in the art or modifications substantially similar thereto.

### First Embodiment

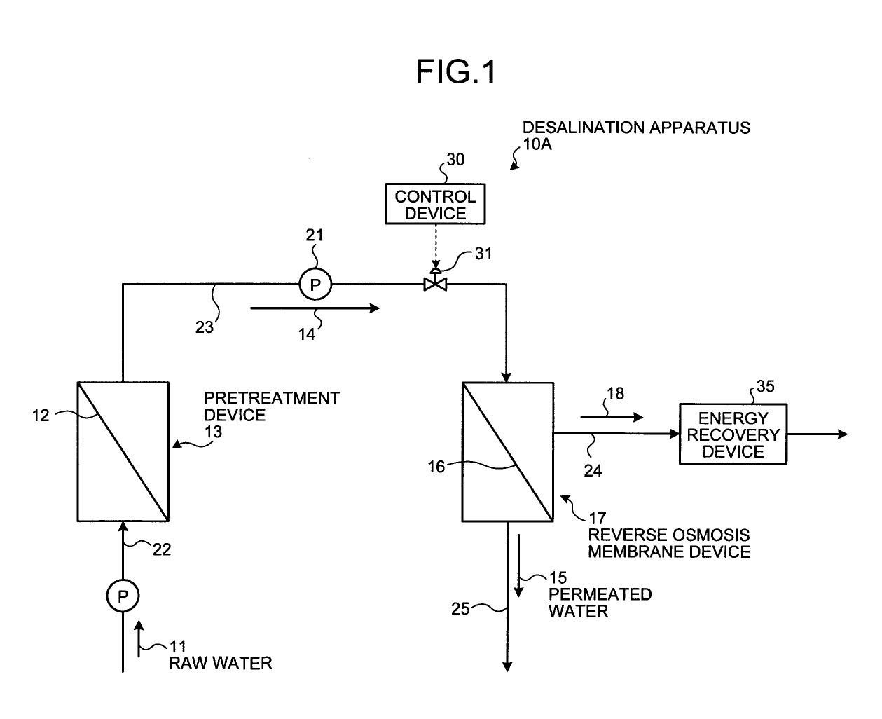

A desalination apparatus according to a first embodiment of the present invention is described with reference to FIG. 1. FIG. 1 is a schematic of the desalination apparatus according to the first embodiment. The same reference numeral is used for the constituent member identical to that of the desalination apparatus according to the conventional technology, and duplicated descriptions are omitted.

As shown in FIG. 1, this desalination apparatus 10A according to the present invention includes: the pretreatment device 13 having the pretreatment membrane 12 that filters a turbid content contained in the raw water 11; the reverse osmosis membrane device 17 having the reverse osmosis membrane 16 that reduces a salt content contained in the filtrate water 14 supplied through the pretreatment device 13 to produce the permeated water 15; a first control valve 31 that is provided between the high-pressure pump 21 mounted on the filtrate water line 23 through which the filtrate water 14 is supplied from the pretreatment device 13 to the reverse osmosis membrane device 17 and the reverse osmosis membrane device 17, and temporarily decreases a supply pressure of the filtrate water 14; and a control device 30 that operates the first control valve 31 so as to perform suck-back control by which a pressure at the entrance of the reverse osmosis membrane device 17 is decreased in a pulse-like manner during operation.

The first control valve 31 mounted on the filtrate water line 23 is configured so that the valve can be closed in a pulse-like manner. Preferably, the first control valve 31 is closed for 1 to 30 minutes. More preferably, the first control valve 31 is closed for 2 to 15 minutes.

If an operating pressure (supply pressure) is decreased to be smaller than a predetermined pressure, the control device 30 instructs the first control valve 31 to be closed. An operating pressure may be decreased, for example, from 6 MPa to equal to or smaller than 2 MPa. Then, a reverse flow (such back) is facilitated by the forward osmosis of the permeated water 15. Thus, the permeated water 15 reduces the turbid layer deposited on the RO membrane 16.

In this case, the pressure is decreased to be equal to or smaller than 2 MPa by adjusting of an opening degree of the first control valve 31, considering the osmotic pressure of the seawater. A reducing performance may be enhanced by facilitating the reverse flow by further decreasing the pressure.

The control by which a pressure of the filtrate water 14 is decreased in a pulse-like manner during the operation according to the present invention includes: cleaning the RO membrane 16 by one time pulse-like pressure fluctuation; and cleaning the surface of the RO membrane 16 by a plurality of repeated pulse-like pressure fluctuations.

According to the present invention, the first control valve 31 that generates the suck back of the permeated water 15 is mounted on the permeated water line 25. Therefore, an energy recovery device 35 can be installed on the concentrated water line 24. As a result, unlike a conventional desalination apparatus, energy of the concentrated water 18 can be recovered with the recovery device 35 with a pressure of the filtrate water 14 still maintained at a high level (if a supply pressure is, for example, 6 MPa, the pressure may be about 5.5 MPa that is slightly smaller than 6 MPa). Thus, energy that is required for driving the high-pressure pump 21 can be secured, or a pressure of the filtrate water 14 can be converted to be higher. Therefore, an energy efficiency of the seawater desalination facility can be enhanced.

Incidentally, for example, known energy recovery devices such as a Pelton Wheel type energy recovery device, a Turbochager type energy recovery device, a PX (Pressure Exchanger) type energy recovery device, and a DWEER (Dual Work ExchangerEnergy Recovery) type energy recovery device may be used as the energy recovery device 35.

As described above, according to the present embodiment, a turbid layer of the RO membrane 16 can be reduced without stopping the operation performed by the high-pressure pump 21 and without using highly-concentrated sodium chloride solution.

### [Test]

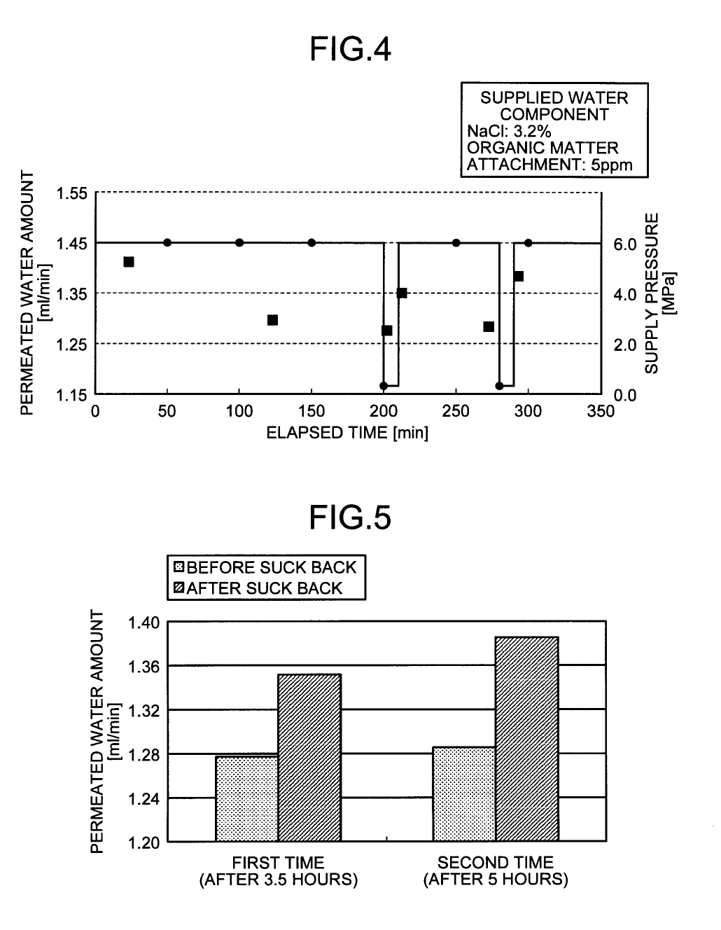

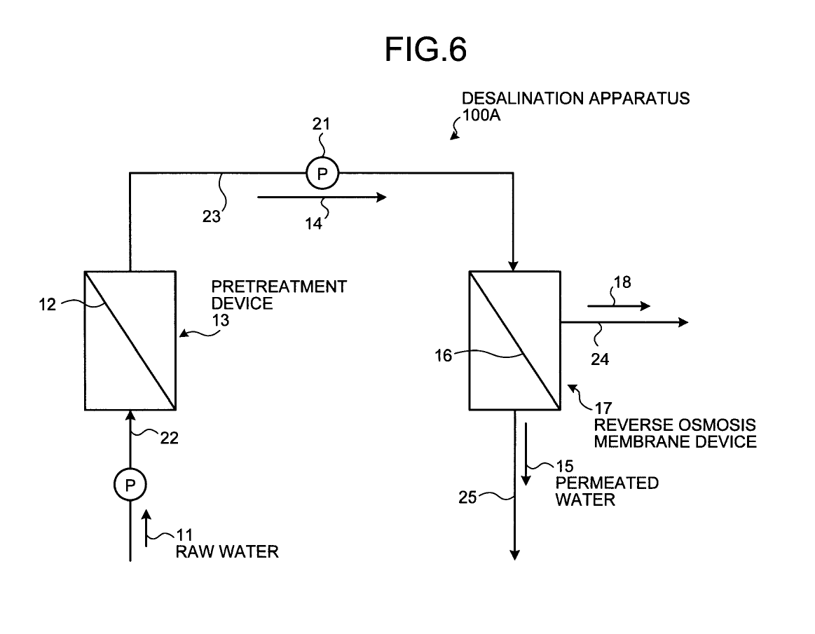

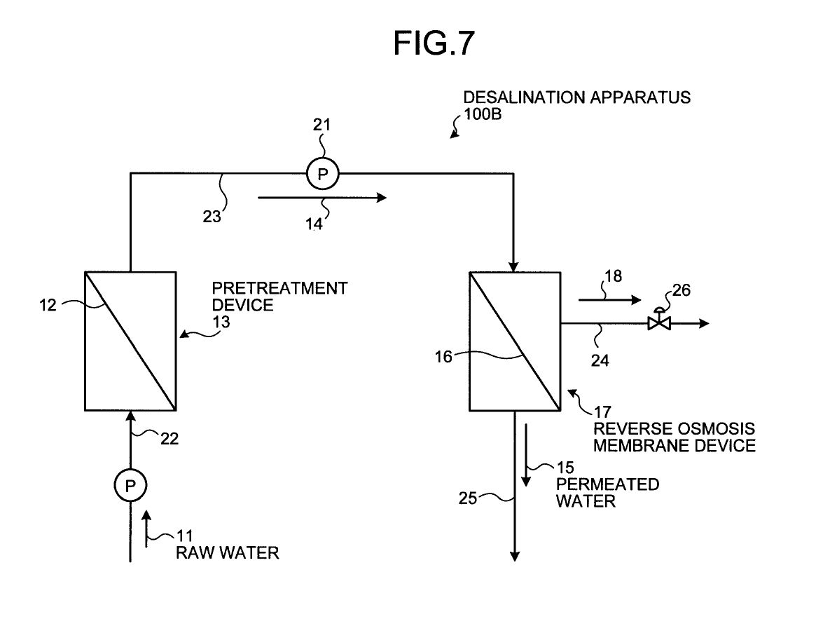

A test in which effects of the present invention are shown is described. Incidentally, FIG. 4 is a diagram depicting relationship between elapsed time of operation and an amount of permeated water and a supply pressure in the test. FIG. 5 is a diagram depicting an amount of the permeated water fluctuation in the test.

A supply pressure of the filtrate water 14 in normal operation was, as shown in FIG. 4, 6.0 MPa. In the beginning of the operation, an amount of the permeated water 15 was about 1.45 ml/min. As operation time of seawater desalination process elapses, an amount of permeated water changed and was 1.3 ml/min after 100 minutes. After 200 minutes (at this point, an amount of permeated water is 1.28 ml/min), suck-back control was performed for the first time in which the first control valve 31 was closed in a pulse-like manner. By the suck-back control, a pressure thereof was dropped to be 0.2 MPa, and the pressure thereof was maintained at 0.2 MPa for about 5 minutes. Then, the first control valve 31 was opened again so that the pressure thereof was recovered to be 6.0 MPa, which was the pressure before the suck-back control.

Incidentally, 5 ppm of organic matter was mixed into 3.2 percent NaCl, and the resultant organic matter was attached on the RO membrane 16, thereby forming organic matter attachment on the RO membrane 16. Thus, the turbid layer for simulation attached on the RO membrane 16 was made.

The amount of permeated water after the first control performed 3.5 hours after the start of the test was measured to be a recovering level of 1.34 ml/min.

The operation was continued, and 260 minutes after the test has started (at this point, the amount of permeated water was 1.29 ml/min), suck-back control was performed for the second time by closing the first control valve 31. By the suck-back control, the pressure was dropped to be 0.2 MPa and the pressure was maintained at 0.2 MPa about for 5 minutes. Then, the first control valve 31 was opened again so that the pressure was recovered to be 6.0 MPa that was the pressure when the test started.

The amount of permeated water after the second control performed 5 hours after the start of the test was measured to be a recovering level of 1.38 ml/min.

Thus, it was determined that an amount of permeated water was recovered by performing the control according to the present invention. Thus, a desalination apparatus can be cleaned safely and stably without stopping the high-pressure pump 21 and without using chemicals and the like. The desalination apparatus can be operated for longer period of time with a high energy efficiency.

A cost reduction can be estimated as follows, taking into account an operating rate of a seawater desalination plant to which the present invention is applied.

In a facility in which plain water is produced at a rate of 200,000 m³/day, once a high-pressure pump is stopped, it takes about 2.5 days to reach a stable state after the high-pressure pump is stopped and restarted.

If the high-pressure pump is stopped in this manner four times a year, the facility is stopped ten days a year. Thus, an operating rate of the facility is reduced by 3 percent.

Thus, if the high-pressure pump is not stopped, a desalination cost of the facility can be reduced by 3 percent.

If no chemicals are used, 100,000 kilograms of chemicals is saved in each cleaning. A cost of chemicals is 30 yen/kg. Therefore, about a hundred million yen can be saved each year. In a desalination plant in which plain water is produced at a rate of 200,000 m³/day, it is estimated that a desalination cost can be reduced about by 1 yen/m³. A desalination cost at present is about 100 yen/m³. Therefore, a desalination cost can be reduced by 1 percent.

### Second Embodiment

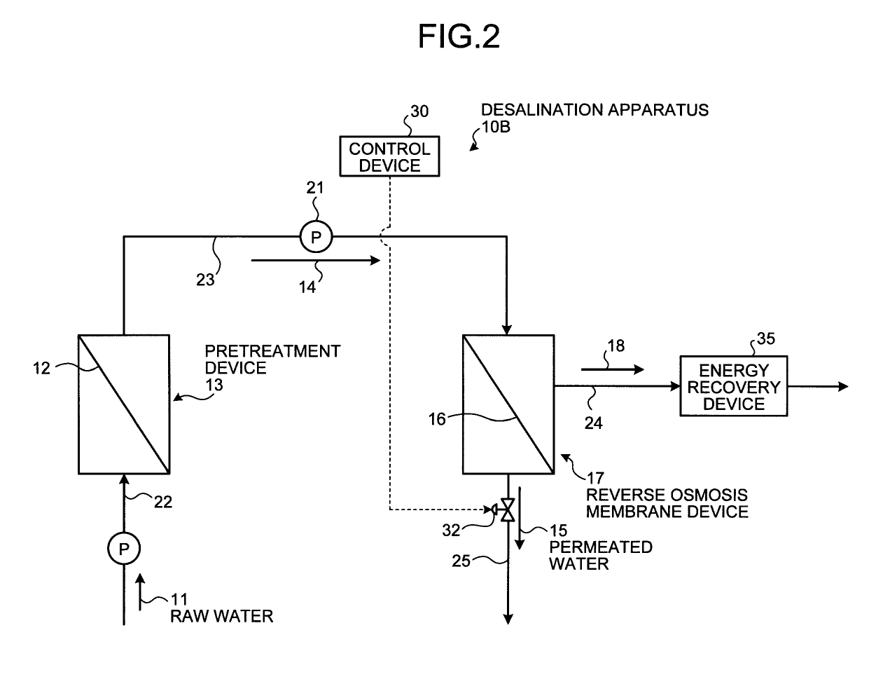

A desalination apparatus according to a second embodiment of the present invention is described with reference to a drawing. FIG. 2 is a schematic of a desalination apparatus according to the second embodiment. The same reference numeral is used for the constituent member identical to that of the desalination apparatus according to the first embodiment, and duplicating descriptions are omitted.

As shown in FIG. 2, in this desalination apparatus 10B, a second control valve 32 by which a pressure of the permeated water 15 is temporarily increased is mounted on the permeated water line 25, instead of the first control valve 31 in the desalination apparatus 10A shown in FIG. 1.

If a pressure of the permeated water 15 becomes smaller than a predetermined value, an operation is performed during operation by which a pressure of the permeated water 15 is increased in a pulse-like manner. Thus, a reverse flow is generated therein due to forward osmosis, thereby cleaning the surface of the RO membrane 16.

According to the present embodiment, an operation by which a pressure on the side of the permeated water 15 is increased in a pulse-like manner is performed during operation. Thus, a deposit layer deposited on the surface of the reverse osmosis membrane 16 is reduced by the flow of the permeated water 15 caused by forward osmosis phenomenon.

### Third Embodiment

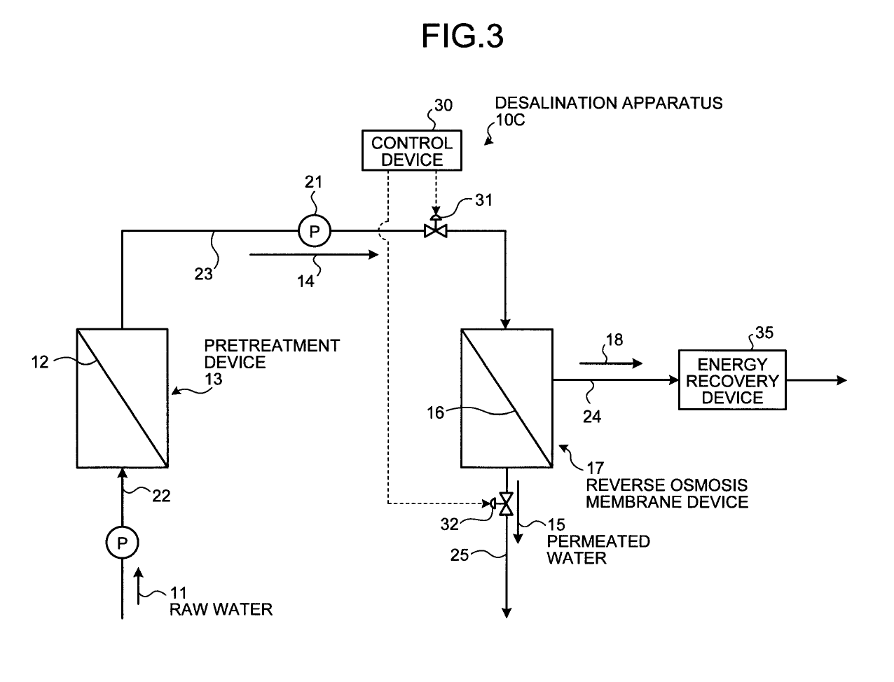

A desalination apparatus according to a third embodiment of the present invention is described with reference to a drawing. FIG. 3 is a schematic of the desalination apparatus according to the third embodiment. The same reference numeral is used for the constituent member identical to that of the desalination apparatus according to the first embodiment, and duplicating descriptions are omitted.

As shown in FIG. 3, a desalination apparatus 10C includes: the first control valve 31 that is mounted on the filtrate water line 23 and by which a supply pressure of the raw water is temporarily decreased according to the first embodiment; and the second control valve 32 that is mounted on the permeated water line 25 and by which a pressure of the permeated water 15 is temporarily increased according to the second embodiment.

According to operating situation of the desalination apparatus 10C, either one of the control valves may be closed. Thus, the surface of the RO membrane can be cleaned.

More specifically, because abrupt pressure fluctuation is not favorable for the high-pressure pump 21, the pressure may be decreased to a predetermined pressure, for example, 2 MPa, by operating the first control valve 31 to perform suck-back control in a pulse-like manner to clean the membrane. Then, if the supply pressure is not recovered to a desirable value, the second control valve 32 may be operated so as to perform an operation by which the pressure on the side of the permeated water is increased in a pulse-like manner. Thus, a deposit layer on the surface of the RO membrane 16 is reduced by the flow of the permeated water 15 caused by forward osmosis phenomenon.

### INDUSTRIAL APPLICABILITY

As described above, in a desalination apparatus according to the present invention, a contamination layer on a reverse osmosis membrane can be reduced without stopping the seawater desalination. Thus, the seawater desalination can be continuously performed to enhance energy efficiency of seawater desalination.

### EXPLANATIONS OF LETTERS OR NUMERALS

10A to 10C desalination apparatus
11 raw water
12 pretreatment membrane
13 pretreatment device
14 filtrate water
15 permeated water
16 reverse osmosis membrane
17 reverse osmosis membrane device
23 filtrate water line
24 concentrated water line
25 permeated water line
30 control device
31 first control valve
32 second control valve

1. A desalination apparatus comprising:
a pretreatment device having a pretreatment membrane that filters a turbid content contained in raw water;
a reverse osmosis membrane device having a reverse osmosis membrane that reduces a salt content contained in filtrate water supplied from the pretreatment device to produce permeated water;
a first control valve that is provided between a high-pressure pump mounted on a filtrate water line through which the filtrate water is supplied from the pretreatment device to the reverse osmosis membrane device and the reverse osmosis membrane device, and that temporarily decreases a supply pressure of the filtrate water; and
a control device that controls the first control valve to decrease an inlet pressure of the reverse osmosis membrane device in a pulse-like manner during operation.

2. A desalination apparatus comprising:
a pretreatment device having a pretreatment membrane that filters a turbid content contained in raw water;
a reverse osmosis membrane device having a reverse osmosis membrane that reduces a salt content contained in filtrate water supplied from the pretreatment device to produce permeated water;
a second control valve that is mounted on a permeated water line through which the permeated water is supplied from the reverse osmosis membrane device, and temporarily increases a pressure of the permeated water; and
a control device that controls the second control valve to increase a pressure of the permeated water in a pulse-like manner during operation.

3. A desalination apparatus comprising:
a pretreatment device having a pretreatment membrane that filters a turbid content contained in raw water;
a reverse osmosis membrane device having a reverse osmosis membrane that reduces a salt content contained in filtrate water supplied from the pretreatment device to produce permeated water;
a first control valve that is provided between a high-pressure pump mounted on a filtrate water line through which the filtrate water is supplied from the pretreatment device to the reverse osmosis membrane device and the reverse osmosis membrane device, and temporarily decreases a supply pressure of the filtrate water;
a second control valve that is mounted on a permeated water line through which permeated water is supplied from the reverse osmosis membrane device, and temporarily increases a pressure of the permeated water; and
a control device that controls any one of the first control valve and the second control value or both of them to perform any one of an operation by which a pressure at an entrance of the reverse osmosis membrane device is decreased in a pulse-like manner during operation and an operation by which a pressure of the permeated water is increased in a pulse-like manner during operation or both of them.

4. The desalination apparatus according to claim 1, further comprising an energy recovery device that is mounted on a concentrated water line, and recovers energy of concentrated water having a high pressure.

5. A method of cleaning a desalination apparatus by using a reverse osmosis membrane device having a reverse osmosis membrane that reduces a salt content contained in raw water to produce permeated water, the method comprising:
providing a first control valve that temporarily decreases a supply pressure of the raw water to the reverse osmosis membrane device;
decreasing an inlet pressure of the reverse osmosis membrane device in a pulse-like manner during operation;
generating a reverse flow due to forward osmosis; and
cleaning a surface of the reverse osmosis membrane.

6. A method of cleaning a desalination apparatus by using a reverse osmosis membrane device having a reverse osmosis membrane that reduces a salt content contained in raw water to produce permeated water, the method comprising:
providing a second control valve that temporarily increases a pressure of the permeated water supplied from the reverse osmosis membrane device,
increasing a pressure of the permeated water in a pulse-like manner during operation;
generating a reverse flow due to forward osmosis; and
cleaning a surface of the reverse osmosis membrane.

7. The desalination apparatus according to claim 2, further comprising an energy recovery device that is mounted on a concentrated water line, and recovers energy of concentrated water having a high pressure.

8. The desalination apparatus according to claim 3, further comprising an energy recovery device that is mounted on a concentrated water line, and recovers energy of concentrated water having a high pressure.
